(19) United States
(12) Patent Application Publication
(10) Pub. No.: US 2023/0314305 A1
(43) Pub. Date: Oct. 5, 2023

(54) ELECTROCHEMICAL FLOW CELL FOR CORROSION AND BIOCORROSION STUDIES WITH DIFFERENT FLUIDS UNDER HYDRODYNAMIC PIPELINE CONDITIONS

(71) Applicant: Instituto Mexicano del Petróleo, Mexico City (MX)

(72) Inventors: Luis Manuel Quej Ake, Mexico City (MX); Norma Icoquih Zapata Peñasco, Mexico City (MX); Gerardo Zavala Olivares, Mexico City (MX); Vicente Garibay Febles, Mexico City (MX)

(21) Appl. No.: 17/976,194

(22) Filed: Oct. 28, 2022

(30) Foreign Application Priority Data
Apr. 4, 2022 (MX) MX/A/2022/004099

(51) Int. Cl. G01N 17/02

(52) U.S. Cl. CPC G01N 17/02

(57) ABSTRACT

The present disclosure provides a scaled-up electrochemical flow cell for performing corrosion and biocorrosion studies of different types of metallic materials, including pipeline steels and new materials. The volume of the cell depends on the dimensions of the cell design, construction, assembly and testing or on the needs and requirements of the user or customer. The cell contains three working electrodes of different geometries (cylinder, disk, and rectangular); a reference electrode coupled to a Luggin capillary and an auxiliary electrode, which are used to determine corrosion rates by the electrochemical and gravimetric method and consists of the adaptation of the following components: (1) lid with hermetic seal with four inlets for electrode placement (auxiliary, working and reference); (2) threaded joint to place the auxiliary electrode; (3) ground joint to place the working electrode (disk or cylindrical) for electrochemical tests; (4) ground joint to place the reference electrode coupled to a Luggin capillary with platinum tip; (5) threaded joint to place the rectangular corrosion coupon for electrochemical tests; (6) threaded coupling to hold the pipe type working electrode and to place a piping system for solution inlet; (7) machined working electrode in pipe form for electrochemical and gravimetric tests; (8) threaded joint to place the pipe type working electrode and solution inlet; (9) threaded opening for solution outlet; (10) threaded opening for coolant inlet; (10) threaded opening for coolant inlet; (11) threaded opening for coolant outlet; (12) magnetic stirrer location. The cell can operate under different fluid flow conditions, simulating different hydrodynamic pipe patterns.

### CROSS REFERENCE TO RELATED APPLICATIONS

The present application claims priority of Mexican patent application number MX/a/2022/004099 filed Apr. 4, 2022.

### FIELD

The present disclosure relates to the field of experimental devices which perform corrosion and biocorrosion studies on different metals exposed to fluids, which simulate flow patterns found in hydrodynamic pipeline conditions.

### BACKGROUND

The internal corrosion process of metallic materials is due to the physicochemical and electrochemical interaction of the different fluids they carry, which bring with them microorganisms capable of inducing biocorrosion. The phenomenon of corrosion and biocorrosion is determined and analyzed by means of the electrochemical method with an arrangement of three electrodes: working, reference and auxiliary, as shown in FIG. 1; or the gravimetric method using coupons of any metallic material of rectangular, disk, and cylindrical geometry.

The electrochemical flow cell documented in industrial reference A50T110 (Radiometer Analytical, “C145/170, Flow Cell A50T110”) is a glass cell with a volume capacity of 250 mL. The cell is designed with a three-electrode array (including accessories) to perform electrochemical tests in flow condition as shown in FIG. 1. In this cell, the exposed area of the working electrode is 0.95 cm². The reference electrode is a saturated calomel electrode and the auxiliary electrode is a platinum disk electrode with an exposed area of 0.785 cm² (1.0 cm diameter). The cell design ensures optimal positioning of the three electrodes for best electrochemical response using homogeneous solutions. However, the design of this cell does not consider an adapted system for temperature control. Furthermore, the cell is designed for the characterization of single-phase solutions, i.e., it is possible to study miscible solutions such as natural aqueous solutions (seawater, production water, and oilfield produced water) and synthetic solutions.

Additionally, there are several patents associated with inventions for electrochemical studies with flow condition: US399606A (L H. Thaller, “Electrically rechargeable REDOX flow cell”, US patent application US399606A, Dec. 7, 1976); US20150236363A1 (G. D. Polcyn, N. Bredemeyer, C. Roosen, D. Donst, P. Toros, P. Woltering, D. Hoormann, P. Hofmann, S. Köberle, F. Funck, W. Stolp, B. Langanke, “Flow-type electrochemical cell”, US patent application US20150236363A1, Sep. 3, 2012); WO1998/32008 (U. Bilitewski, W. Mascheroder, M. Stiene, I. Rohm, “Electrochemical flow cell”, German Pat. Application WO1998/32008, Jul. 23, 1998); US3151052A (E.P. Arthur, H. L. Friedman, “Electrochemical flow cell”, US Pat. Application US3151052A, May 17, 1962); US4413505A (W. R. Matson, “Electrochemical flow cell, particularly use with liquid chromatography”, US Pat. Application US 2010/0155262 A1, Mar. 9, 1981); however, most use an electrochemical cell with a two-electrode arrangement and homogeneous solutions. Sometimes the cell is designed for small volumes of solution, in order to carry out organic synthesis reactions or for energy production [1-6].

T. Hong, W. P. Jepson, “Corrosion inhibitor studies in large flow loop at high temperature and high pressure”, Corros. Sci., 43 (2001) 1839-1849; G. Koster, M. Ariel, “Electrochemical flow cell”, J. Electroanal. Chemistry Interfacial Electrochem., 33 (1971) 339-349; L. D. Syntrivanis, F. J. del Campo, J. Robertson, “An electrochemical flow cell for the convenient oxidation of Furfuryl alcohols”, J flow Chemistry, 8 (2018) 123-128; J. Genesca, R. Olalde, A. Garnica, N. Balderas, J. Mendoza, R Duran, “Electrochemical evaluation of corrosion inhibitors in CO2 containing brines. An RCE and flow-loop comparison, NACE Corrosion Conference 2010, paper No. 10162, pp. 1-15; T. Hong, Y. H. Sun, W. P. Jepson, “Study on corrosion inhibitor in large pipelines under multiphase flow using EIS”, Corros. Sci., 44 (2002) 101-112; X. Wang, J. Xu, C. Sun, M. C. Yan, “Effect of oilfield produced water on corrosion of pipeline”, Int. J. Electrochem. Sci., 10 (2015) 8656-8667 [7-12].

In the electrochemical flow cells of the present disclosure (e.g., flow cell of FIG. 2), the exposed surfaces presented by the working electrodes of the cell depend on the dimensions of the design, construction, assembly and testing of the cell. The first working electrode can be coupled to an electrode holder. The second working electrode is a section of steel pipe attached to a second electrode holder. The third working electrode consists of a rectangular carbon steel bar. The three-electrode arrangement consists of the working electrode, a calomel electrode as a reference electrode and a platinum mesh as an auxiliary or counter electrode. The auxiliary electrode consists of a platinum mesh or an inert material that does not participate in the electrochemical system. Thus, the construction and adaptation of the cell and electrodes consist of the design of two electrode holders and a Luggin capillary to couple two working electrodes and the reference electrode, respectively, as well as their accessories. In addition, a threaded conduit is used to place a section of carbon steel pipe in order to reproduce the internal corrosion damage due to the physicochemical effect of the fluid and the microorganisms within, which will eventually form a biofilm under flow conditions. Thus, the electrochemical flow cell design can accommodate a variable volume of solution depending on the dimensions of the cell design and construction and operate at different flow conditions (laminar and turbulent). This cell is designed and machined from any material capable of withstanding 20 to 80° C. at operating temperature. This cell is able to carry out the study of two independent and/or combined flow systems: in the first one, the fluid is transported through a hydraulic pump, and in the second one, the fluid is activated by means of a magnetic stirrer, which is used especially for study cases with emulsions. This is done in order to evaluate the shear stresses and biocorrosion processes in different fluids as a function of time and space emulating conditions found in oil and gas pipelines.

The electrochemical flow cells of the present disclosure solve the technical problem of obtaining the best electrochemical response for corrosion and biocorrosion studies using homogeneous solutions in immiscible two-phase and/or multiphase systems such as hydrocarbon and associated water mixture. This electrochemical flow cells of the present disclosure did not previously exist in the prior art because only the design of a conventional electrochemical cell for carrying out corrosion and biocorrosion studies in single-phase or miscible solutions was considered. These electrochemical flow cells icannot be deduced from other prior disclosures because they allow the study and understanding of the corrosion and biocorrosion process of any type of metallic material in immiscible two-phase and/or multiphase mixed solutions and suggests other ways to combat the corrosion process in pipelines affected by interior corrosion and biocorrosion. Among the problems or challenges presented by the corrosion phenomenon is the adsorption-fixation and growth of microorganisms in the form of a biofilm, and the consequent electrochemical imbalance on the metal surface inside a pipeline, in the presence of a fluid with different corrosive agents. These may include but are not limited to water with nutrients, such as seawater, injection water or congenital water (these latter two are commonly referred to as production water), and under hydrodynamic conditions and different temperatures. Until now, internal corrosion in lines and pipelines through which oil and its derivatives are transported, has been studied and related to the presence of sweet and sour media [10-12], its concentration is increasing in current crude oils; however, the participation of other contaminants in this process such as saline media is still unknown for Mexican crude oils. The internal protection process of pipelines that transport hydrocarbons is affected by variations in the concentrations of corrosive species, significant changes in the flow pattern, flow regime and the influence of temperatures in the range of 45 to 60° C. [13,14]. At present, biocorrosion problems continue to be a topic of great scientific and industrial interest because corrosion mechanisms are related to sulfate-reducing microorganisms, organic acid producers, metal reducers and exopolymer generators, as well as high salt concentrations and temperatures at different hydrodynamic pipeline conditions [15-18]. In the electrochemical flow cells of the present disclosure, the design, construction, assembly and testing of an electrochemical flow cell for conducting corrosion and interior biocorrosion studies simulating different fluids with hydrodynamic pipeline conditions is described.

In order to contribute to the knowledge and study of the corrosion and biocorrosion damage mechanism inside pipelines, a solution recommended by the ASTM international standard [19] has been reported that simulates the electrolytes present in saline environments using electrochemical cell designs with different hydrodynamic conditions present in pipelines [1-16]. For example, Hong and co-workers [11] reported the study of the corrosion process in a 15 m long acrylic pipe section with an inner diameter of 101.6 mm subjected to the action of a multiphase flow. This study consisted of the use of a saline solution with CO₂ and the dosage of a molecule that inhibits the corrosion process at different flow conditions, 40° C. and 0.136 MPa, using the electrochemical impedance spectroscopy (EIS) technique. Thus, electrochemical characterization was carried out on a three-electrode array located in a special section of the electrochemical system. In this case, the working electrode was made of 1018 carbon steel. The auxiliary and reference electrodes were 316 L stainless steel. All electrodes had an exposed area of 0.785 cm² (10 mm diameter). In addition, 10 mV of perturbation potential and a frequency window from 5 kHz to 20 mHz were used to plot the EIS spectra. The results of this work showed real and imaginary impedance semicircles of depressive type and diffusion phenomena. Moreover, as a function of exposure time, the real impedance value increased gradually. However, the electrochemical arrangement designed in this work does not correspond to a pipe system, because a three-electrode arrangement using metallic materials such as 1018 steel and 316 L stainless steel was used. In addition, the temperature employed in this work is at the limit used in acrylic vessels. The literature review indicates that there is a lack of information or knowledge on the susceptibility to biocorrosion of pipeline steels and the corrosivity of the associated water for pipelines under hydrodynamic conditions and temperatures. These are important factors for the material choice, design and construction of an electrochemical cell for the investigation of the use of pipe steels in the absence and presence of biofilms. By designing and implementing the electrochemical and gravimetric technique in an electrochemical flow cell and a recirculation system with coolant for temperature control, it will be possible to simulate conditions as close as possible to those of pipeline operation.

Therefore, the design, construction, and assembly of an electrochemical flow cell for corrosion and biocorrosion studies on American Petroleum Institute (API) steels exposed to different fluids with hydrodynamic pipe conditions are recommended. Thus, an electrochemical flow cell was designed to adapt an electrochemical system with a three-electrode array with flow and temperature control systems. The cell is designed to perform at least two independent and/or combined flow systems: in the first one, the fluid is transported through a hydraulic pump, and in the second one, the fluid is activated by means of a magnetic stirrer (especially for case studies with emulsions). In addition, the cell offers a recirculation system for temperature control. In order to carry out electrochemical and gravimetric tests, three types of working electrodes were machined from pipeline steel with different geometries and exposure areas. Therefore, in the present disclosure, the results of electrochemical impedance spectroscopy spectra and corrosion rates obtained by polarization and weight loss curves obtained at different electrode exposure times, subjected to various hydrodynamic and temperature conditions, both in the absence and presence of microorganisms are reported. Furthermore, the procedure to prepare electrolytes simulating associated water and the experimental method to carry out electrochemical tests and corrosion and biocorrosion studies are described. The results obtained demonstrate that the exposure time of the X52 steel in contact with a saline medium containing microorganisms generate important modifications in the development of the biocorrosion of this type of steel, and the user is able to identify the experimental conditions that will be used to continue with the systematic study of this phenomenon in other types of API grade steels exposed to other types of environments found in oil and gas pipelines. Some environments involve the associated water obtained in the field, solutions prepared by means of recommended standards, new coatings, and new microorganisms subjected to different flow and temperature conditions. It is important to mention that the corrosion effect is assessed using electrochemical methods complimented with standardized and non-standardized laboratory tests. Thus, the corrosiveness of a fluid with and without a bacterial strain is performed under stagnant condition where the electrochemical responses are confused. This is because the microorganisms tend to form a compact biofilm system on steel surface that block the charge transfer such that a passivation trend might occur. Therefore, the passivation effect causes the underestimation of the corrosive effect of the microorganisms due to their physiological and biological nature. In the field, it is rare to find the fluid under static conditions, so the design of the electrochemical flow cell of the present disclosure considers both laminar and turbulent flow, promoting the formation of biofilms under flow regimes that are more in line with reality inside a pipeline. In addition, the electrochemical cell is designed to study the corrosion and biocorrosion process of steels in the presence of hydrocarbon-in-water or water-in-hydrocarbon emulsions, when the double hydrodynamic system is applied.

### BRIEF DESCRIPTION OF THE DRAWINGS

FIG. 1. Represents a commercially available flow cell schematic for electrochemical testing.

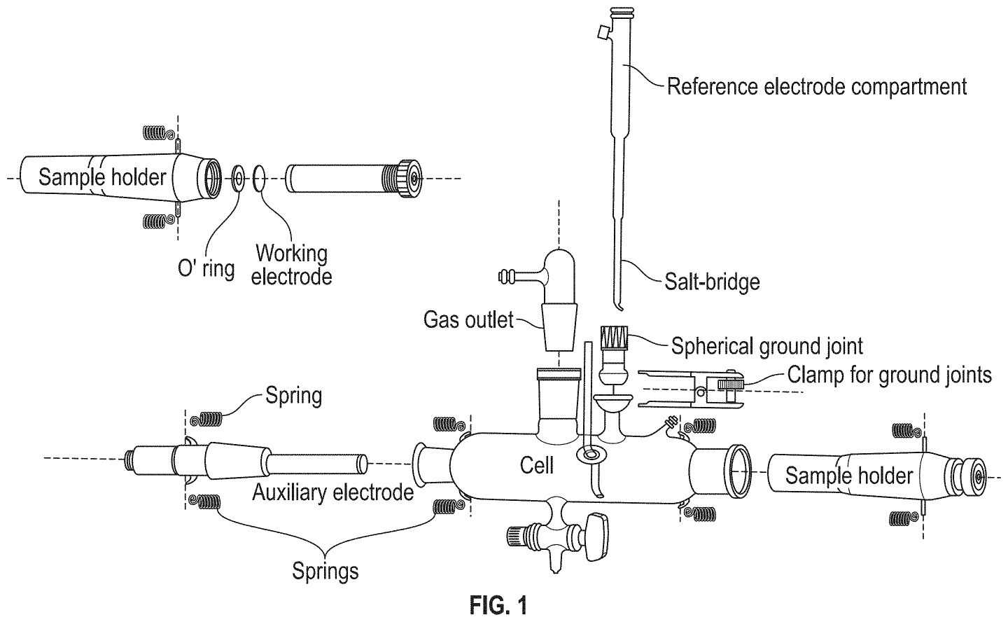

FIG. 2. Represents exemplary electrochemical cell design with flow condition of the present disclosure, where: 1=Top with hermetic seal with the adaptation of four inlets to place working, auxiliary and reference electrodes (disk, cylindrical or rectangular), 2=Threaded gasket for auxiliary electrode inlet, 3=Ground joint to place a disk or cylinder type working electrode coupled to a working electrode holder for electrochemical testing, 4=Ground joint to place a reference electrode coupled with a Luggin capillary with platinum tip, 5=Threaded joint to place a rectangular type working electrode coupled to a working electrode holder for gravimetric tests, 6=Threaded coupling to hold the tubular type working electrode and to place a piping system for solution inlet, 7=Tubular machined working electrode for electrochemical and gravimetric tests, 8=Threaded joint to place the tubular type working electrode for electrochemical and gravimetric tests as well as the solution inlet, 9=Threaded opening for solution outlet, 10=Threaded opening for coolant inlet, 11=Threaded opening for coolant outlet, 12=Location of magnetic stirrer, A=Inner diameter of vessel, B=Inner height of vessel, C=Outer diameter of vessel, D=Outer height of vessel.

FIG. 3. Depicts an exemplary design of the electrochemical cell cover of the present disclosure, where: 2=Threaded joint for auxiliary electrode inlet, 3=Ground joint to place a disk or cylinder type working electrode coupled to a working electrode holder for electrochemical testing, 4=Ground joint to place a reference electrode coupled with a platinum tipped Luggin capillary, 5=Threaded joint to place a rectangular type working electrode coupled with a working electrode holder for gravimetric tests, 8=Threaded joint to place the tubular type working electrode for electrochemical and gravimetric tests as well as solution inlet, 9=Threaded opening for solution outlet, 10=Threaded opening for coolant inlet. 11=Threaded opening for coolant outlet.

FIG. 4. Represents an exemplary working electrode for electrochemical tests coupled to an electrode holder, where: E=Width of sample holder, F=Length of sample holder, G=Length of working electrode, H=Diameter of disk-type working electrode (WE), I=Length of electrode holder, J=Ground adapter with opening, K=Length of coupling to ground adapter with opening, L=Diameter of ground adapter with opening.

FIG. 5. Represents an exemplary pipe section for electrochemical and gravimetric tests, where M=pipe section length, N=pipe diameter.

FIG. 6. Represents an exemplary corrosion coupon for gravimetric testing coupled to an opening section of the electrochemical cell, where O=Diameter of ground adapter with opening, P=Ground adapter with opening, Q=Length of electrode holder, R=Length of fastener with holes and non-metallic screws for working electrode, S=Length of rectangular type working electrode, T=Width of working electrode.

FIGS. 7A and 7B. FIG. 7A: represents a Nyquist plot showing real impedance spectra in ohms.cm² and imaginary impedance in omhs.cm², obtained in a pipe section under two flow conditions; and FIG. 7B: represents a Nyquist plot showing impedance spectra for two types of working electrodes at one flow condition in the absence of microorganisms.

FIG. 8. Represents an exemplary electrical circuit with series-parallel arrangement of Rₛ[(RₒCPEₒ)(R_{ct}CPE_{edl})], where Rₛ is the resistance associated with the solution conductivity and Rₒ is the resistance related with the corrosion products (oxide films) for cases of corrosion studies in the absence of microorganisms or the resistance associated with the biofilm for biocorrosion studies in the presence of microorganisms. CPEₒ is the capacitance related with the corrosion products, oxide films and/or biofilms, CPE_{edl} is the capacitance associated with the electrical double layer and R_{ct} is the resistance associated with charge transfer.

FIGS. 9A and 9B. FIG. 9A: represents exemplary Tafel curves obtained in a pipe section under two flow conditions; and FIG. 9B: represents exemplary Tafel curves obtained for two types of working electrode under one flow condition and in the absence of microorganisms.

FIG. 10. Represents am exemplary Nyquist plot where the real impedance spectra is in ohms.cm² and imaginary impedance is in omhs.cm², obtained from a section of pipe and an X52 steel electrode exposed to seawater in the presence of an aerobic microorganism for biocorrosion studies under one flow conditions at a temperature of 38° C. and 3 hours exposure time.

FIGS. 11A, 11B, 11C, 11D, and 11E, represent exemplary SEM images where the surfaces before and after electrochemical tests in the absence and in the presence of an aerobic microorganism are represented: FIG. 11A: X52 steel before electrochemical test; FIG. 11B: pipe section after electrochemical test and in the absence of microorganisms; FIG. 11C: X52 steel after electrochemical test and in the absence of microorganisms; FIG. 11D: pipe section after electrochemical test and in the presence of microorganisms; and FIG. 11E: X52 steel after electrochemical test and in the presence of microorganisms.

### DETAILED DESCRIPTION OF THE INVENTION

This section describes the design, construction, and an example of the start-up and validation of an electrochemical flow cell of the present disclosure. This includes obtaining and analyzing experimental data from different working electrode geometries exposed in a corrosive medium recommended by ASTM D1141 [19]. A saturated calomel reference electrode is used with a platinum wire as auxiliary electrode (counter electrode). As an example, for obtaining the electrochemical responses and experimental data by weight loss, three steel coupons were machined as working electrodes including the following geometries: the first is an API X52 steel cylinder of 1.0 cm length and 0.635 cm in diameter, offering an exposed area of 0.316 cm²; the second is a section of steel pipe 8 cm long and 1.0 cm internal diameter, offering an exposed internal area of 25.13 cm²; the third is a 2.5 cm ×0.5 cm×0.2 cm rectangular carbon steel bar with two 0.4 cm diameter holes to hold it on an electrode holder, offering an exposed area of 3.45 cm². It is important to mention that the reference electrode is placed in a Luggin capillary in order to avoid contamination of the porous membrane of the reference electrode.

The criteria for the design and construction is based on the knowledge of electrochemical and biocorrosion processes that occur in pipeline steels which are exposed to a flow. The procedure to carry out the design and assembly of an electrochemical flow cell considers the following steps:
A stage of adaptation of different electrode holders to place the working electrode to carry out electrochemical tests.
A stage of adaptation of the single-phase or multiphase flow system under static and hydrodynamic conditions.
A stage of inoculation of the microorganism to carry out biocorrosion studies.

The electrochemical cell is designed and constructed of Pyrex glass with a solution capacity of 700 milliliters. It includes a movable lid designed to adapt and hermetically seal the electrodes (working, auxiliary and reference), as well as the cell itself. Furthermore, the electrochemical cell, peristaltic pump, stirring grid, recirculation system with coolant for temperature control, and potentiostat-galvanostat are mounted in strategic locations.

The advantages and limitations of the electrochemical cell are described below:

### Advantages

It is possible to determine corrosion rate by electrochemical techniques under static conditions.
It is possible to determine corrosion rate by electrochemical and gravimetric techniques under flow conditions.
Characterization of single-phase solutions.
Characterization of multi-phase solutions.
Temperature control consists of a special adaptation (jacketed) for the coolant inlet and outlet, in which the coolant is controlled by means of a recirculation bath.
It is possible to carry out corrosion and biocorrosion studies under flow conditions by means of a hydraulic or peristaltic pump.
It is possible to carry out corrosion and biocorrosion studies under flow conditions using a magnetic stirrer (for studies with emulsions).
It is possible to carry out corrosion and biocorrosion studies on working electrodes under flow conditions by adapting a rotating cylinder electrode.
It is possible to carry out corrosion and biocorrosion studies on working electrodes subjected to flow conditions by adapting a rotating disk electrode.
It is possible to carry out corrosion and biocorrosion studies under flow conditions using a double hydrodynamic system for emulsion formation.
Controlled dosing of inert gases to mitigate oxygen present in the test solution.
Aerobic and anaerobic bacteria can be evaluated.

### Limitations

Characterization of solutions up to a temperature of 70° C.
Characterizations of corrosive solutions at atmospheric pressure.
Maximum flow rate will depend on the capacity of the pump used.

As an example, the overall dimensions of the electrochemical cell system are as follows:
8.5 cm internal diameter.
12.0 cm height.
3.5 cm thick jacket for the temperature control system.

The electrochemical cell is equipped with a peristaltic pump, hoses, a magnetic stirrer and a stirring grid to recirculate and stir the solution under study. In addition, the cell has a glass shell located on the outside of the cell body, a recirculation bath, hoses and other accessories for temperature control in the electrochemical system. The electrochemical cell should preferably be placed near an exhaust hood so that in case of gas emission it can be discharged safely.

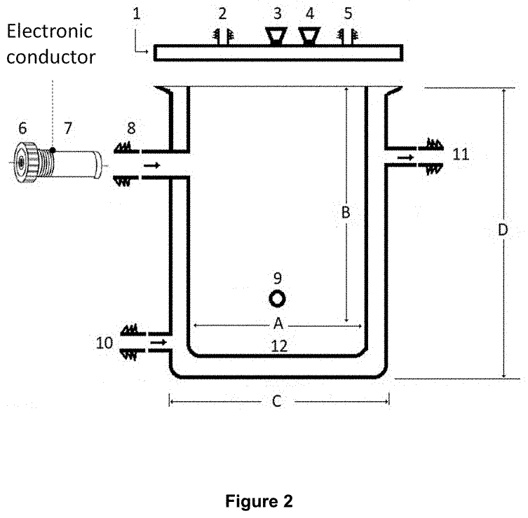

FIG. 2 shows a schematic of the electrochemical cell with the adaptation of two ground joints to accommodate the working and reference electrode holders. The adaptation of a 9 mm threaded joint is intended to place the auxiliary electrode (counter electrode), and the second 9 mm threaded joint is adapted to place an electrode holder to hold a 2.5 cm×0.5 cm×0.2 cm rectangular carbon steel bar with two 0.4 cm diameter holes, providing an exposed area of 3.45 cm². The cell is designed to study a double hydrodynamic system as is the case when carrying out studies with emulsions. The first is attributed to flow through a peristaltic pump. The second is attributed to a circular motion using a magnetic stirrer. Additionally, the cell is designed to carry out other types of hydrodynamic studies using the rotating disk electrode and the rotating cylinder electrode as working electrodes.

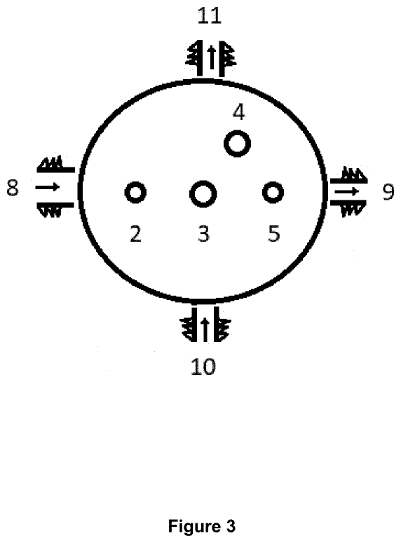

FIG. 3 shows the design of the electrochemical cell lid. The working electrode should preferably be placed in the ground joint located at the central part of the cell lid.

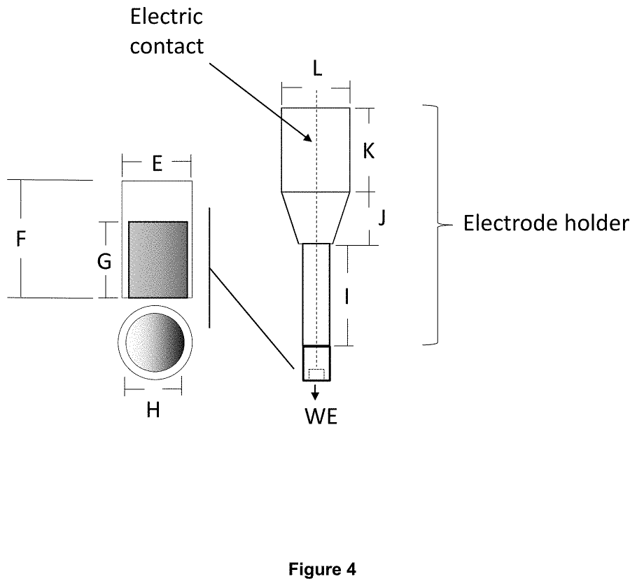

FIG. 4 shows the design of a working electrode (WE) offering an exposed area of 0.316 cm², which is integrated into a Teflon electrode holder, which is threaded at the end of the electrode holder and uses a saturated Calomel reference electrode and a platinum mesh as an auxiliary electrode to perform AC current measurements, i.e., electrochemical impedance spectroscopy and direct current spectroscopy such as Tafel curves in aqueous media.

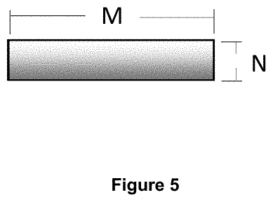

FIGS. 4 and 5 show the front and side view schematics of the disk-shaped and tubular working electrode (WE) arrangement, respectively, in order to determine the Reynolds number. This is simulated by testing fluid flow in the cylinder and in the pipe section, observing the effect on the angular velocity around both working electrodes [20]. The steel pipe section has a length of 8.0 cm and internal diameter of 1.0 cm, providing an exposed internal area of approximately 25.13 cm². In field engineering practices, the Reynolds number equation involves the pipe diameter (D in m), the fluid velocity (V in m/s), the fluid density (ρ in kg/m³) and the dynamic viscosity of the fluid (μ in kg/ms): Re=VDρ/μ, so there is a direct relationship between the Re number and the diameter of the system. As the diameter of the working electrode increases the Reynolds number increases; and vice versa, if the cross-sectional area of the electrode is reduced the Reynolds number decreases. Furthermore, it is necessary to have Re values>2000 to achieve turbulent flow. However, there are flow conditions under which different shear stresses are generated depending on the flow rate and type of electrode arrangement, as described below:

Re_{for a pipe section}=VDρ/μ (1)

Re_{RDE or RCE}=2r²ω(1/v) (2)

τ_{RDE o RCE}=0.0791ρω²r²Re^{-0.3} (3)

where RDE is the rotating disk electrode, RCE is the rotating cylinder electrode, τ is the shear stress (N/m²); ω is the angular velocity (rad/s); r is the cylinder radius (cm); v is the kinematic viscosity (m²/s). In Table 1 the Reynold's number and shear stresses are presented as a function of fluid velocity for an API X52 steel disk of diameter 0.635 cm with an exposed area of 0.316 cm² using a sour water solution with ρ=1025 kg/m³ and μ=0.00065 kg/ms (v=1.046 m²/s). The second working electrode is a section of steel pipe 8.0 cm long and with a 1.0 cm internal diameter, providing an exposed internal area of approximately 25.13 cm². As can be seen, both the fluid velocity and the diameter of the working electrodes generate considerable shear stresses on the surface of the working electrode. However, in field practices, the value of Re will depend on the flow rate of the transported hydrocarbon, the physicochemical properties of the hydrocarbon and the diameter of the pipeline.

TABLE 1
The hydrodynamic ratio between rotation speed and shear
stress for a rotating disk electrode and a pipe section.

| Fluid velocity | Rotating disk | | Pipe section | |
|---|---|---|---|---|
| (m/s) | Re | τ (N · m⁻²) | Re | τ (N · m⁻²) |
| 0.16 | 832 | 0.29 | 4128 | 0.56 |
| 0.33 | 1664 | 0.96 | 8256 | 1.82 |
| 0.49 | 2497 | 1.92 | 12385 | 3.64 |
| 0.66 | 3329 | 3.14 | 16513 | 5.94 |

Table 2 presents the calculation of the Re number for a 30-inch internal diameter pipeline at different flow rates, where the pipeline area is 0.435 m², the internal diameter is 0.7445 m, and μ=1.046 m²/s. It is important to note that the fluid velocity of 100 and 160 thousand barrels per day (TBD) generates Re values similar to those calculated in the working electrodes, that is why it is important to design this flow cell to simulate as much as possible the effect of the corrosion and biocorrosion process under flow conditions.

TABLE 2
The hydrodynamic ratio between flow and Re for an oil pipe of
low carbon steel with 762 mm (30 inches) outside diameter.

| Flow rate in thousands | | | |
|---|---|---|---|
| of barrels per day | Volumetric | Velocity | |
| (TBD) | flow (m³/s) | (m/s) | Re |
| 100 | 0.184 | 0.423 | 3000 |
| 160 | 0.331 | 0.719 | 5100 |
| 200 | 0.391 | 0.899 | 6300 |
| 450 | 0.880 | 2.02 | 15000 |

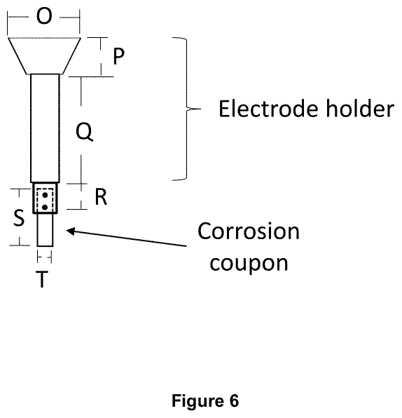

For the elaboration of the third working electrode holder, a solid Teflon rod was fabricated. The working electrode (corrosion coupon) is made of API X52 steel of 2.5 cm×0.5 cm×0.15 cm. This electrode was drilled to obtain two 0.4 cm diameter holes to hold it with an electrode holder, offering an exposed area of 3.45 cm². FIG. 6 shows the accessories that made up this type of corrosion coupon coupled to an electrode holder.

In order to carry out the validation of the electrochemical cell, a synthetic seawater solution recommended by ASTM D1141 [19] was used as the electrolytic medium.

### Characterization Methodology

### Example of the Electrochemical Cell Start-Up Procedure

Determination of electrochemical parameters, gravimetric tests and analysis of corrosion rate values were carried out on working electrode surfaces of 0.316 cm² for the disk, 25.13 cm² for the pipe section and 3.45 cm² for the corrosion coupon in contact with a seawater solution and the addition of a microorganism for biocorrosion studies.

### Experimental

The materials used in the development of this work are the following:
Beaker of 500 mL.
Test tube of 500 mL.
Test tube of 100 mL.
Spatula.
Saturated calomel reference electrode.
Platinum wire as auxiliary electrode.
Working electrode holder.
Luggin capillary.
Carbon steel working electrodes:
   Disk type electrode with an exposure area of 0.316 cm² (0.635 cm diameter).
   Tube section of 1.0 cm diameter and 8.0 cm length offering an exposure area of 25.13 cm².
   2.5 cm×0.5 cm×0.2 cm corrosion test specimens providing an exposure area of 3.45 cm² for the gravimetric test.
Magnetic stirrer (in case of carrying out studies with emulsions generated by means of a double hydrodynamic system).
Thermometer.
Hoses.
Elbows.
Connections.
Container for organic waste deposits.

The equipment that were run for the electrochemical testing stage were the following:
Heat unit with a speed rotation system.
Small pump model of the Glant 1-AA-MD.
Isothermal bath model of the Thermomix 1460.
Electrochemical cell made of glass of 680 mls of the total volume coupled to a flow system and an isothermal bath.

Ultrasonic bath.

The used reagents were:
Synthetic seawater recommended by ASTM D1141 [19]. The used reagents were in wt. %: NaCl (24.53), MgCl₂ (5.20), Na₂SO₄ (4.09), CaCl (1.16), KCl (0.695), NaHCO₃ (0.201), KBr (0.101), H₂BO₃ (0.027).
Microorganisms.
Inhibited acid.

### The Electrochemical and Gravimetric Results Were Obtained by the Following Steps

1) Carry out mechanical roughing of the working electrodes (for electrochemical tests, the disk type electrode of 0.316 cm² exposure area, for gravimetric tests, the steel plate of 2.5 cm×0.5 cm×0.2 cm with an exposure area of 3.45 cm²) using 600 grit sandpaper, then clean the steel surface with acetone for 30 seconds using an ultrasonic bath. Place the electrode in the working electrode holder and introduce it into the cell.
2) Carry out surface cleaning of the tube section using inhibited hydrochloric acid and bidistilled water. It is important to highlight that this type of electrode can obtain electrochemical data (open circuit potential, impedance, Tafel curves, among others) and gravimetric data (weight loss).
3) In the case of the gravimetric method, note the initial and final weight of the working electrode before and after the test.
4) Place the glass cell on the heating and stirring rack.
5) Using hoses and fittings, connect the water inlet and outlet of the isothermal bath to the glass cell.
6) Connect the inlets and outlets of the glass cell to the inlet and outlet of the flow pump.
7) Once the flow system of the glass cell is adequate, turn on the isothermal bath until a temperature in the range of 25-70° C. is reached. In this case study, a temperature of 38° C. was used.
8) Add 600 mL of seawater to the glass cell.
9) For case studies with emulsions, add a magnetic stirrer inside the electrochemical cell.
10) For case studies observing biocorrosion, add an aerobic microorganism at a concentration of 10⁹ cells/mL of solution.
11) Place the lid on the glass cell.
12) Place the working electrodes in their respective electrode holders.
13) Place the working, reference, and auxiliary electrodes on the adaptations designed on the cell lid.
14) Activate the flow system by turning on the reflux pump until the desired flow rate is reached.
15) Wait for the cell to reach a temperature of 38° C. using the isothermal bath.
   a) During the wait time required to reach 38° C. in the cell with the mixture, carry out the mechanical roughing of the electrode on the steel plates up to 600 grit sandpaper. Next, clean the surface of the steel with deionized water and place it in the working electrode holder.
   b) Place the steel plates in the electrochemical cell in the presence of the corrosive solution under study and keep in contact with the solution for an exposure time of three hours under flow conditions.
   c) Make sure that the equipment (recirculation bath, grill, potentiostat-galvanostat, and peristaltic pump) are correctly connected to the electric current source.
   d) Turn on the control panel of the potentiostat-galvanostat and the computer equipment.
   e) Carry out the electrochemical and gravimetric tests.

### Obtaining and Validating the Experimental Curves Using Electrochemical Techniques

The electrochemical evaluation is carried out using a potentiostat-galvanostat.

The recommended methodology for obtaining open circuit potential spectra, electrochemical impedance and polarization curves (Tafel curves) is described below:
1. Proceed to open the software for electrochemical testing.
2. Enter the software to label and set up the experimental conditions for open circuit potential (OCP) and electrochemical impedance spectroscopy (EIS).
   a) OCP: Evaluate for three hours.
   b) EIS: evaluate at the initial time of electrode immersion and after monitoring the OCP at three hours.
   c) Obtain polarization curves after three hours.
16) Place the terminals of the working, reference and auxiliary electrodes located in the Autolab 100N potentiostat with the electrochemical arrangement of three electrodes.
17) On both steel coupons, initially plot the impedance spectrum using a perturbation potential of ±10 mV peak-to-peak amplitude in a frequency range from 100 kHz to 0.01 Hz.
18) After impedance testing at the initial time, obtain OCP values referred to a saturated calomel reference electrode (SCE) for three hours.
19) Once the OCP values are obtained, plot the impedance spectrum.
20) After the impedance test, obtain polarization curves. Electrochemical responses are obtained using an applied potential of ±250 mV (potential sweep) and a potential sweep rate of 1 mV/s.
21) After the electrochemical tests, disconnect the electrode terminals from the potentiostat.
   a. Disconnect the heating grid with stirring.
   b. Remove all electrodes from the electrochemical cell lid.
   c. Remove the cell lid.
   d. Deposit the residue of the solution in absence and presence of microorganism, in a special container for inorganic residues.
   e. Wash the glass electrochemical cell and the flow pump by recirculating soapy water for 5 minutes.
   f. Finally, clean the cell by recirculating a water-ethanol mixture at a ratio of 20-80.
22) Carry out the experimental data processing.
23) Analyze the graphs according to the requirements of the analysis.

### Collection and Validation of Experimental Data Using the Gravimetric Method

Recommended procedure for the determination of corrosion rates by coupon weight loss:
1. Clean the electrodes with inhibited acid followed by deionized water and a special brush.
2. Dry the electrodes.
3. Obtain the final weight of the coupons without oxide.

Methodology for the determination of the corrosion rate by weight loss of the coupons after the gravimetric test. Taking into account the difference in weight of the coupons (initial weight—final weight), it is possible to determine the values of the corrosion rates. NACE TM0169 and NACE RP0775 [21,22] recommend using the following equation (4) for the determination of the corrosion rate (CR) in millimeters/year (mm/year):

$$CR ( \frac{mm}{year} ) = \frac{( {W}_{i} - {W}_{f} ) 365 , 000}{A ρ t} \qquad ( 4 )$$

where Wᵢ is the initial weight of the working electrode (g) and W_{f} is its final weight (g); A denotes the total surface area of the tube under test in contact with the fluid in (mm²); ρ is the density of the metallic material (g/cm³); and t is test duration time in days.

### Results of the Evaluation and Validation by Electrochemical and Gravimetric Method

The electrochemical characterization of three types of working electrodes exposed in synthetic seawater was carried out in order to validate the adaptation of an electrochemical flow cell for corrosion and biocorrosion studies simulating hydrodynamic conditions and operating temperatures found in typical pipelines.

### Description of the Electrochemical Experimental Curves

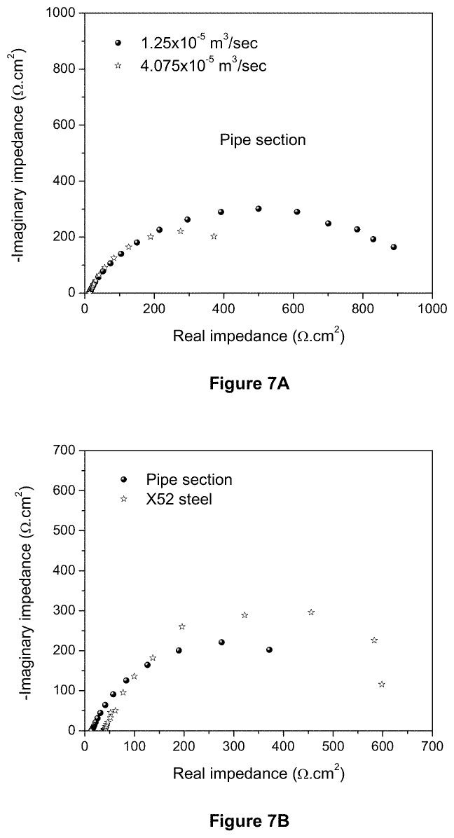

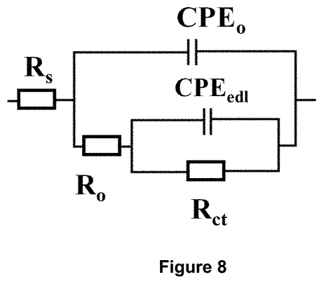

FIGS. 7A and 7B illustrate the electrochemical impedance spectroscopy responses of different working electrodes exposed to seawater at a temperature of 38° C. under two flow conditions. FIG. 8 shows the electrical circuit used to perform a best fit of the experimental data. The parameters of the electrical elements involved in the fit are shown in Table 3.

TABLE 3
Electric parameters obtained from the best fitting of the
experimental data of two types of working electrodes: a
pipe section and a X52 steel exposed to seawater at 38°
C. under two flow condition, and 3 hours of exposure time.

| | | | | | |
|---|---|---|---|---|---|
| Volumetric | | | CPEₒ × | | CPE_{edl} × |
| flow | Rₛ | Rₒ | 10⁻⁴ | R_{ct} | 10⁻⁴ |
| (m³/s) | (Ω · cm²) | (Ω · cm²) | (F/cm²) | (Ω · cm²) | (F/cm²) |

Pipe section

| | | | | | |
|---|---|---|---|---|---|
| 1.25 × 10⁻⁵ | 10 | 74 | 2.92 | 820 | 1.44 |
| 4.075 × 10⁻⁵ | 10 | 70 | 3.08 | 380 | 3.31 |

X52 steel

| | | | | | |
|---|---|---|---|---|---|
| 4.075 × 10⁻⁵ | 48 | 82 | 1.91 | 691 | 1.72 |

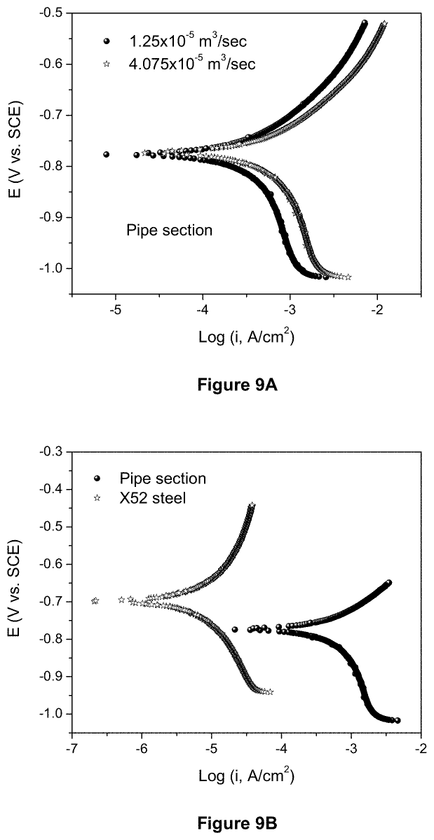

FIGS. 9A and 9B show the responses of the polarization curves of a section of steel pipe under two flow conditions and the comparison between the two types of working electrodes. The parameters of the electrical elements involved in the adjustment are shown in Table 4.

TABLE 4
Kinetic parameters obtained from the experimental data of
a pipe section and a X52 steel under flow condition: steels
exposed to seawater at 38° C., and 3 hours of exposure.

| | | | | | |
|---|---|---|---|---|---|
| Volumetric | | | | | |
| flow | E_{corr} | βₐ | −β_{c} | i_{corr} | CR |
| (m³/s) | (V vs. SCE) | (V/dec) | (V/dec) | (A/cm²) | (mm/year) |

Pipe section

| | | | | | |
|---|---|---|---|---|---|
| 1.25 × 10⁻⁵ | −0.77304 | 0.14298 | 0.26367 | −3.31931103 | 0.22 |
| 4.075 × 10⁻⁵ | −0.77531 | 0.08421 | 0.07709 | −4.68254695 | 0.48 |

X52 steel

| | | | | | |
|---|---|---|---|---|---|
| 4.075 × 10⁻⁵ | −0.699 | 0.36219 | 0.36054 | −5.06 | 0.10 |

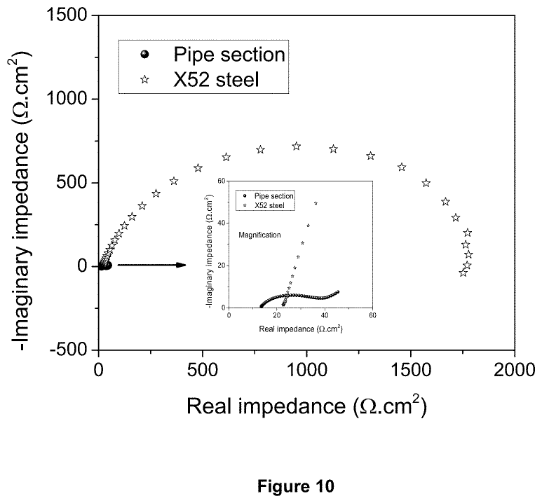

FIG. 10 shows the Nyquist diagram responses of X52 steel exposed to seawater at a flow rate of 4.075×10⁻⁵ m³/s, at 38° C. and three hours of exposure in the presence of microorganism for biocorrosion studies. The parameters of the electrical elements involved in the setup are shown in Table 5.

TABLE 5
Electric parameters obtained from the best fitting of the
experimental data of two types of working electrodes for
biocorrosion studies under flow condition: a pipe section
and a X52 steel exposed to seawater in the presence of an
aerobic microorganism at 38° C. and 3 hours of exposure time.

| | Rₛ | Rₒ | CPEₒ | R_{ct} | CPE_{edl} |
|---|---|---|---|---|---|
| Steel | (Ω · cm²) | (Ω · cm²) | (μF/cm²) | (Ω · cm²) | (μF/cm²) |
| Pipe section | 13 | 26 | 125 | 37 | 16.5 |
| X52 steel | 22 | 1419 | 667.6 | — | — |

### Description of Gravimetric Experimental Data

Table 6 shows the CR values obtained on two types of steels exposed to seawater at 4.075×10⁻⁵ m³/s, at 38° C. and three hours of exposure, both in the absence and in the presence of the microorganism.

TABLE 6
Corrosion rates obtained on two X52 steel electrodes exposed to
seawater in the absence and presence of an aerobic microorganism
under one flow condition, 38° C., and 3 hours of exposure.

| | | | | |
|---|---|---|---|---|
| | Initial | Final | | |
| | weight | weight | Difference | CR |
| System | (g) | (g) | (g) | (mm/year) |

Without microorganism

| | | | | |
|---|---|---|---|---|
| Pipe section | 26.8548 | 26.8369 | 0.0179 | 1.12 |
| X52 steel | 1.3283 | 1.3269 | 0.0014 | 0.088 |

With microorganism

| | | | | |
|---|---|---|---|---|
| Pipe section | 26.6568 | 26.6486 | 0.0082 | 0.72 |
| X52 steel | 1.1442 | 1.1439 | 0.0003 | 0.20 |

### Description of the Evaluation and Validation by the Spectroscopic Method

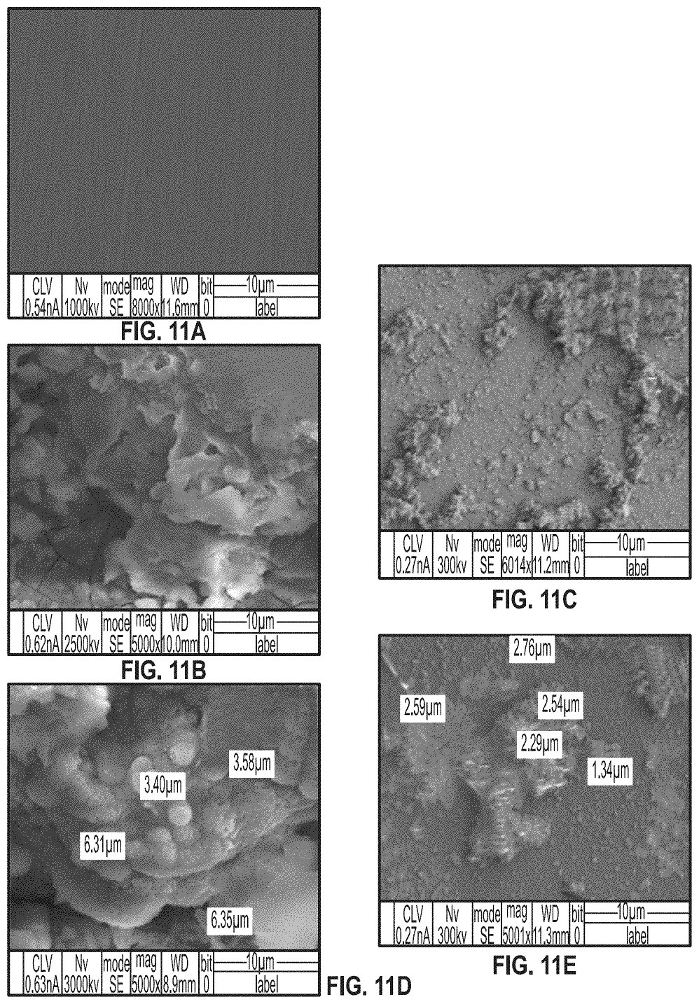

FIG. 11 shows the scanning electron microscope images of different X52 steel surfaces exposed to seawater at a flow rate of 4.075×10⁻⁵ m³/s, at 38° C. and three hours exposure both in the absence and presence of microorganism for biocorrosion studies.

### References

[1] Radiometer Analitycal, C145/170, Flow Cell A50T110, www.radiometer-analytical.com.
[2] L H. Thaller, “Electrically recargable REDOX flow cell”, US patent application US399606A, Dec. 7, 1976.
[3] G. D. Polcyn, N. Bredemeyer, C. Roosen, D. Donst, P. Toros, P. Woltering, D. Hoormann, P. Hofmann, S. Köberle, F. Funck, W. Stolp, B. Langanke, “Flow-type electrochemical cell”, US patent application US20150236363A1, Sep. 3, 2012.
[4] U. Bilitewski, W. Mascheroder, M. Stiene, I. Rohm, “Electrochemical flow cell”, German Pat. Application WO1998/32008, Jul. 23, 1998.
[5] E. P. Arthur, H. L. Friedman, “Electrochemical flow cell”, US Pat. Application US3151052A, Sep. 29, 1964.
[6] W. R. Matson, “Electrochemical flow cell, particularly use with liquid chromatography”, US Pat. Application US 2010/0155262 A1, Mar. 9, 1981.
[7] T. Hong, W. P. Jepson, “Corrosion inhibitor studies in large flow loop at high temperature and high pressure”, Corros. Sci., 43 (2001) 1839-1849.
[8] G. Koster, M. Ariel, “Electrochemical flow cell”, J. Electroanal. Chemistry Interfacial Electrochem., 33 (1971) 339-349.
[9] L. D. Syntrivanis, F. J. del Campo, J. Robertson, “An electrochemical flow cell for the convenient oxidation of Furfuryl alcohols”, J flow Chemistry, 8 (2018) 123-128.
[10] J. Genesca, R. Olalde, A. Garnica, N. Balderas, J. Mendoza, R Duran, “Electrochemical evaluation of corrosion inhibitors in CO₂ containing brines. An RCE and flow-loop comparison”, NACE Corrosion Conference 2010, paper No. 10162, pp. 1-15.
[11] T. Hong, Y. H. Sun, W. P. Jepson, “Study on corrosion inhibitor in large pipelines under multiphase flow using EIS”, Corros. Sci., 44 (2002) 101-112.
[12] X. Wang, J. Xu, C. Sun, M. C. Yan, “Effect of oilfield produced water on corrosion of pipeline”, Int. J. Electrochem. Sci., 10 (2015) 8656-8667.
[13] Quej-Ake L M, Contreras A, Liu H B, Alamilla J L, Sosa E., “The effect of the hydrodynamic and temperature on corrosion rate of API steels exposed to oilfield produced water”, Anti-Corros. Methods and Mater., 66 (2019) 101-114.
[14] Yu J, Li J, Gan F., “High temperature naphthenic acid corrosion of steel in high TAN refining media”, Anti-Corros. Methods and Mater., 55(2008) 257-263.
[15] N. Zaveri, Sun R., Zufelt N., Zhou A., Chen Y. Q., “Evaluation of microbially influenced corrosion with electrochemical noise analysis and signal processing”, Corros. Sci., 52 (2007) 5795-5807.
[16] Cataneda H., Benetton X. D., “SRB-biofilm influence in active corrosion sites formed at the steel-electrolyte interface when exposed to artificial seawater conditions”, Corros. Sci., 50 (2008) 1169-1183.
[17] Wu T., Xu J., Sun C., Yan M., Yu C., Ke W., “Microbiological corrosion of pipeline Steel under yield stress in soil environment”, Corros. Sci., 88 (2014) 291-305.
[18] Bao Q., Zhang D., Lv D., Wang P., “Effects of two main metabolites of sulphate-reducing bacteria on the corrosion of Q235 steels in 3.5 wt. % NaCl media”, Corros. Sci., 65 (2012) 405-413.
[19] ASTM D1141. Standard Practice for the Preparation of Substitute Ocean Water, ASTM, West Conshohocken, PA, 2013.
[20] S. Nešié, G. T. Solvi, and J. Enerhaug, “Comparison of the Rotating Cylinder and Pipe Flow Tests for Flow-Sensitive Carbon Dioxide Corrosion”, Corrosion Vol 51 No. 10 (1995).
[21] NACE Standard TM0169. Laboratory corrosion testing of metals, NACE International, Houston, Texas, 2012.
[22] NACE Standard RP0775. Preparation, installation, analysis, and interpretation of corrosion coupons in oilfield operations, NACE International, Houston, Texas, 2018.

1. An electrochemical flow cell, characterized in that it contains three working electrodes for corrosion and biocorrosion studies by electrochemical and/or gravimetric methods.

2. The electrochemical cell according to claim 1, characterized in that it includes a rotating disk or a rotating cylinder electrode that simulates hydrodynamic conditions of pipelines to determine the shear stress in stimulated emulsions for two-phase or multiphase systems.

3. The electrochemical cell according to claim 1, characterized in that it operates at atmospheric pressure and temperatures up to 70° C.
